(19) United States
(12) Patent Application Publication
(10) Pub. No.: US 2016/0111835 A1
(43) Pub. Date: Apr. 21, 2016

(54) Bonding Washer For A Solar Panel Racking System

(71) Applicant: Polar Racking Inc., Toronto (CA)

(72) Inventor: Manish Nayar, Windsor (CA)

(21) Appl. No.: 14/884,457

(22) Filed: Oct. 15, 2015

Related U.S. Application Data
(60) Provisional application No. 62/064,575, filed on Oct. 16, 2014.

(51) Int. Cl. H01R 25/14; H02S 40/34; H01R 4/30; H02S 20/23

(52) U.S. Cl. CPC H01R 25/142; H02S 20/23; H02S 40/34; H01R 4/304

(57) ABSTRACT

There is provided a washer for electrically bonding metallic components. In an embodiment, there is provided a washer for bonding metallic components of a solar panel racking system. The washer comprises an upper surface and a lower surface, a series of spaced apart upper protrusions on the upper surface, and a series of spaced apart lower protrusions on the lower surface. Each upper protrusion corresponds to an opposing one of the lower protrusions to form an upper and lower protrusion pair. Each upper and lower protrusion pair is formed along a common plane. Compression of the washer between the metallic components causes the protrusions to at least partially embed into the components and to electrically bond the components.

### CROSS-REFERENCE TO RELATED APPLICATION

This application claims priority to and the benefit of U.S. Provisional Patent Application No. 62/064,575 entitled “Bonding Washer For A Solar Panel Racking System”, filed on Oct. 16, 2014, the entire disclosure of which is hereby incorporated by reference.

### FIELD

The present disclosure relates to washers adapted to improve bonding for electrical grounding, or bonding washers. In one particular embodiment, the disclosure relates to bonding washers for use with support systems and/or support racks for solar panels used to generate electrical power from solar radiation.

### BACKGROUND

Solar panels are typically mounted over surfaces, such as residential or commercial building rooftops, using solar panel racking systems. The racking systems commonly comprise a series of longitudinal rails, that span the length of a rooftop from one side to the other, and a series of lateral rails disposed perpendicular to the longitudinal rails. Each lateral rail is typically shaped and dimensioned to define a channel for slidably receiving an edge of a solar panel, and is releasably attached to a longitudinal rail. Such racking systems are typically formed from metal and/or metal alloys. In order to properly ground a racking system, one or more of the rails are connected to an electrical ground. It is therefore necessary to ensure that the entire racking system is properly bonded so that each component thereof is electrically grounded.

### SUMMARY

There is provided a washer for electrically bonding metallic components of a solar panel racking system. The washer includes an upper surface and a lower surface, a series of spaced apart upper protrusions on the upper surface, and a series of spaced apart lower protrusions on the lower surface. Each upper protrusion corresponds to an opposing one of the lower protrusions to form an upper and lower protrusion pair. Each upper and lower protrusion pair is formed along a common plane. Compression of the washer between the metallic components causes the protrusions to at least partially embed into the components and to electrically bond the components.

There is also provided a washer for electrically bonding metallic components of a solar panel racking system, the components releasably securable to each other by a plurality of clamps, each of the clamps including a nut, the washer, including an upper surface and a lower surface, a series of spaced apart upper protrusions on the upper surface, a series of spaced apart lower protrusions on the lower surface, downwardly depending flanges that releasably secure the washer to the nut to maintain a fixed arrangement between the washer and the nut, each of the upper protrusions corresponding to an opposing one of the lower protrusions to form an upper and lower protrusion pair, each upper and lower protrusion pair being formed along a common plane, wherein compression of the washer between the metallic components causes the protrusions to at least partially embed into the components and to electrically bond the components, the protrusions being substantially aligned with the components when the washer and the nut are in said fixed arrangement.

Further there is provided a washer for electrically bonding metallic components of a solar panel racking system, the components releasably securable to each other by a plurality of clamps, each of the clamps including a nut, the washer including an upper surface and a lower surface, a series of spaced apart upper protrusions on said upper surface, a series of spaced apart lower protrusions on said lower surface, downwardly depending flanges that releasably secure the washer to the nut to maintain a fixed arrangement between the washer and the nut, the flanges being flexibly resilient and each flange including an inwardly extending louver, wherein, as the washer is received onto the nut, the louvers frictionally traverse the nut until the louvers clear the nut, thereafter the louvers extending beneath the nut to retain the washer on the nut, each of the upper protrusions corresponding to an opposing one of the lower protrusions to form an upper and lower protrusion pair, each upper and lower protrusion pair being formed along a common plane, wherein compression of the washer between the metallic components causes the protrusions to at least partially embed into the components and to electrically bond the components, the protrusions being substantially aligned with the components when the washer and the nut are in the fixed arrangement.

Further aspects of the disclosure will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper perspective view of a solar panel racking system with bonding washers constructed in accordance with an embodiment of the present invention;

FIG. 2 is an enlarged detail of portion 2′ of FIG. 1;

FIG. 3 is an upper perspective view of a bonding washer constructed in accordance with an embodiment of the present invention;

FIG. 4 is a side view of the bonding washer of FIG. 3;

FIG. 5 is a bottom perspective view of the bonding washer of FIG. 3;

FIG. 6 is a top view of the bonding washer of FIG. 3;

FIG. 7 is a side view of the bonding washer of FIG. 3 positioned immediately above a nut;

FIG. 8 is an upper perspective view of the bonding washer of FIG. 3 releasably secured to the nut;

FIG. 9 is a bottom perspective view of the bonding washer and nut of FIG. 8;

FIG. 10 is a bottom view of the bonding and nut of FIG. 8;

FIG. 11 is a side perspective view of the bonding washer of FIG. 3 releasably secured to a nut coupled to a clamp;

FIG. 12 is a side view of FIG. 2, without the lateral rails shown;

FIG. 13 is a side view of FIG. 2;

FIG. 14 is a front view of FIG. 2;

FIG. 15 is an upper perspective view of a bonding washer constructed in accordance with an alternate embodiment of the present invention;

FIG. 16 is a side view of the bonding washer of FIG. 15; and

FIG. 17 is an upper side perspective view of the bonding washer of FIG. 15 releasably secured to a nut coupled to a clamp.

### DETAILED DESCRIPTION

The present invention may be embodied in a number of different forms. The specification and drawings that follow describe and disclose some of the specific forms of the invention.

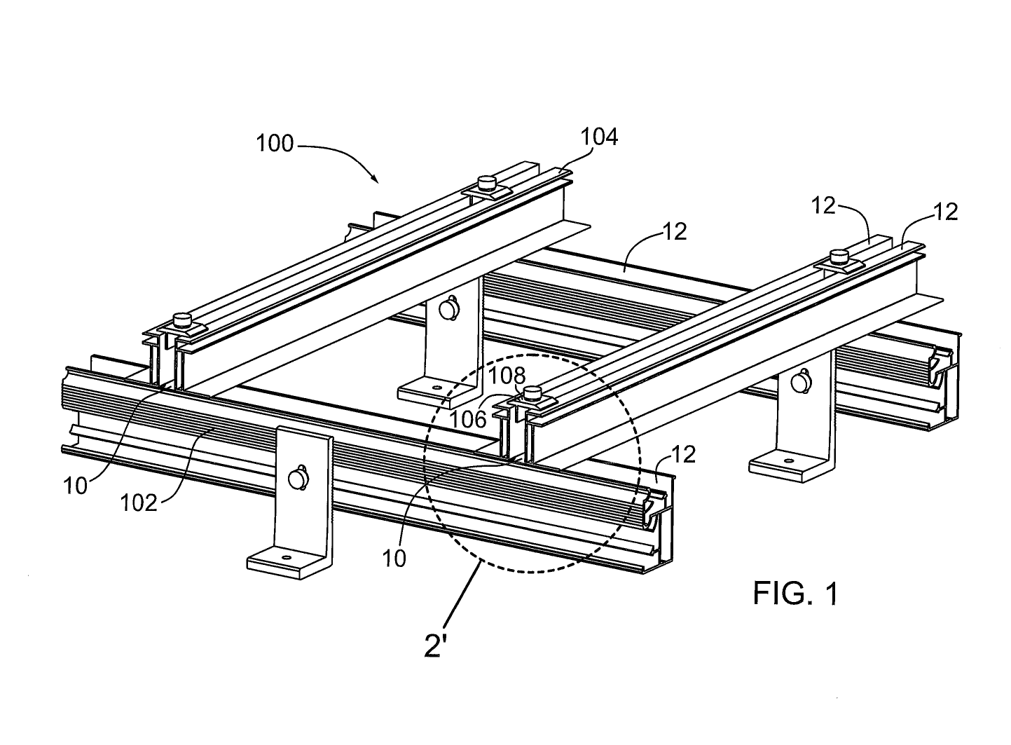

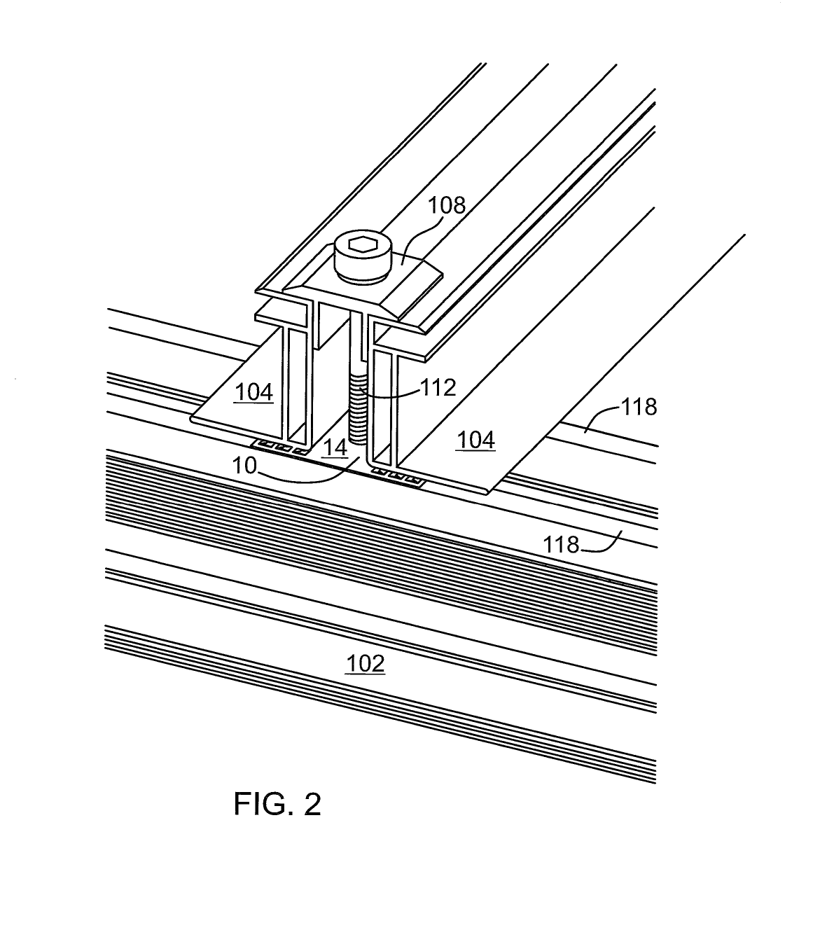

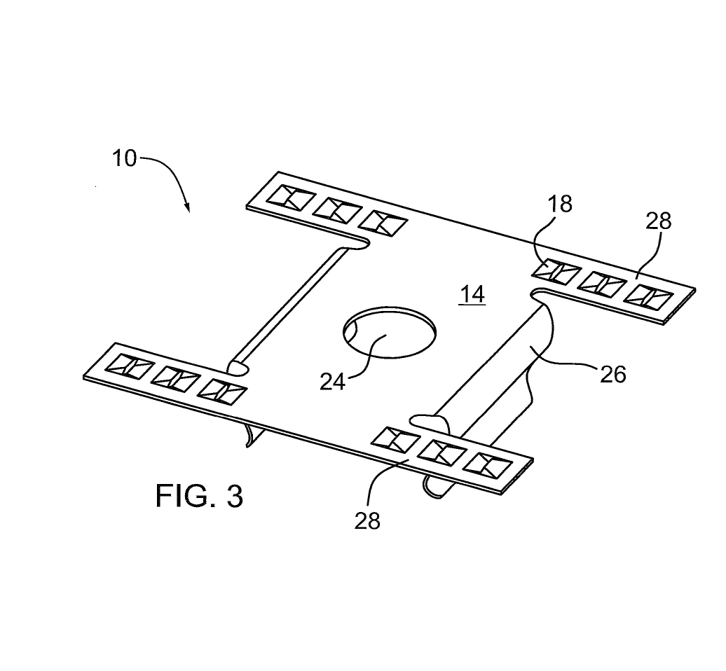

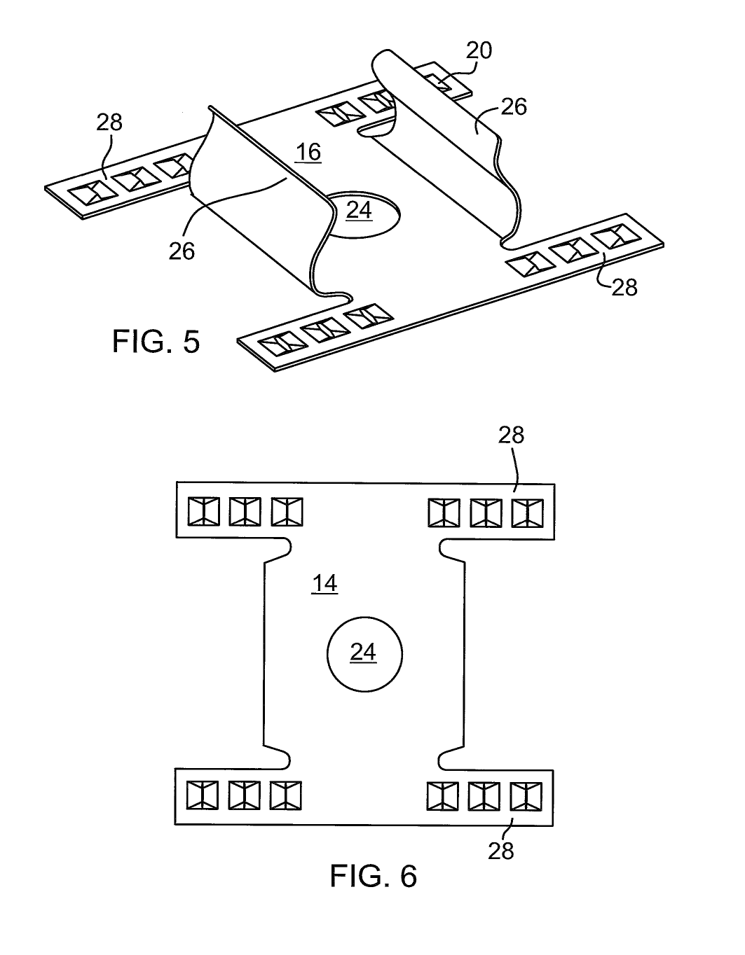

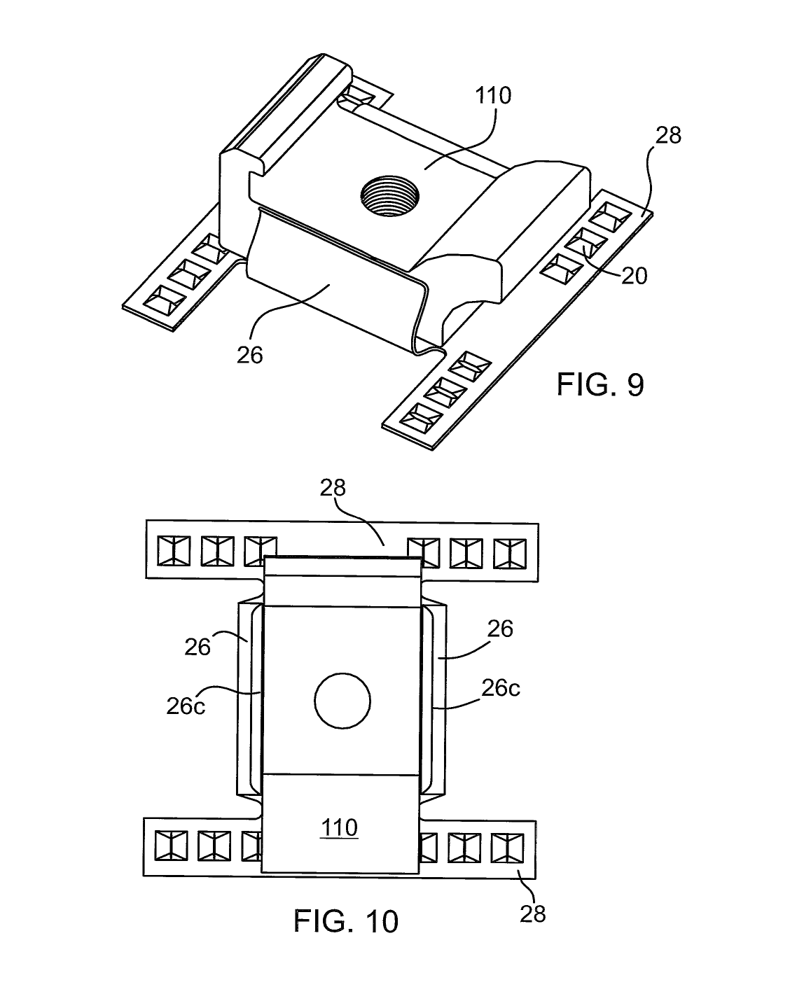

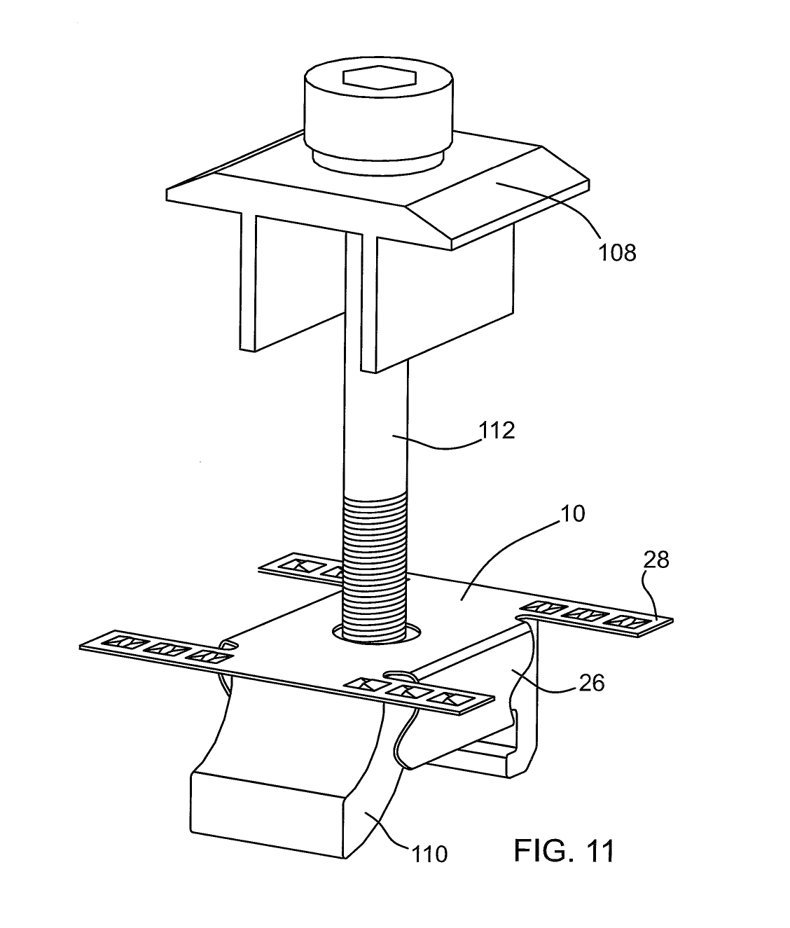

Referring to FIGS. 1 to 14, a bonding washer constructed in accordance with an embodiment of the invention is noted generally by reference numeral 10. While the bonding washer may be used to electrically bond metallic components 12 of a solar panel racking system 100, it may also be used to electrically bond metallic components of other structures.

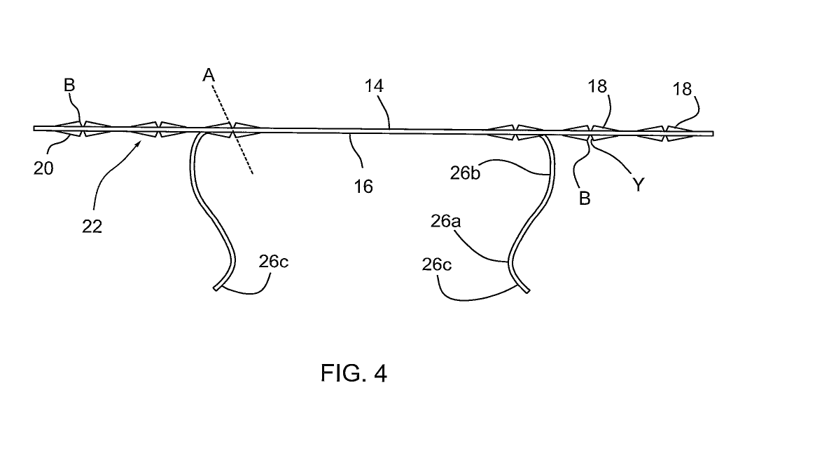

As shown in FIG. 4, washer 10 includes an upper surface 14 and a lower surface 16.

Lances or protrusions are formed on each of the surfaces, the upper surface having a series of spaced apart upper protrusions 18, and the lower surface having a series of spaced apart lower protrusions 20. Each upper protrusion corresponds to an opposing lower protrusion to form an upper and lower protrusion pair 22.

In the embodiments shown in the figures, each protrusion has a generally rectangular top profile (see, e.g., FIG. 6). Further, and as shown in FIG. 4, each protrusion has a generally triangular side profile, with each triangular side profile having a rise “Y” extending from the respective upper or lower washer surface to a protrusion tip “B”. Each upper and lower protrusion pair is formed along a common plane “A”, so that rise “Y” of each protrusion 18, 20 of a pair 22 lies or substantially lies on plane “A”. Plane “A” may be normal or perpendicular to the upper and lower washer surfaces, or oblique, slanted or sloped in relation to the upper and lower washer surfaces.

Further, while the bonding washer has been shown with protrusions having a generally rectangular top profile, protrusions of other configurations may be used. For example, lances or protrusions having a top view profile that is pointed, oval, hexagonal, parabolic, hyperbolic, elliptical, circular, or a rhombus or equilateral quadrilateral, such as a square, diamond or lozenge profile, are within the scope of the present disclosure.

A user of bonding washer 10 will be able to compress the washer between metallic components 12 to cause the upper and lower protrusions to be at least partially embedded into the metallic components in order to electrically bond the components. The washer will typically be formed from a metal that is harder than that of the metallic components to facilitate the embedding of the protrusions into the metallic components.

The protrusions shown in the attached figures have a rise “Y” of approximately 1 mm in length, although protrusions having other dimensions are within the scope of the present disclosure. It will be appreciated that the length chosen for the rise of the protrusions may depend on the thickness of the metallic components into which they are to at least partially embed, and/or the relative hardness of the protrusions and/or the metallic components.

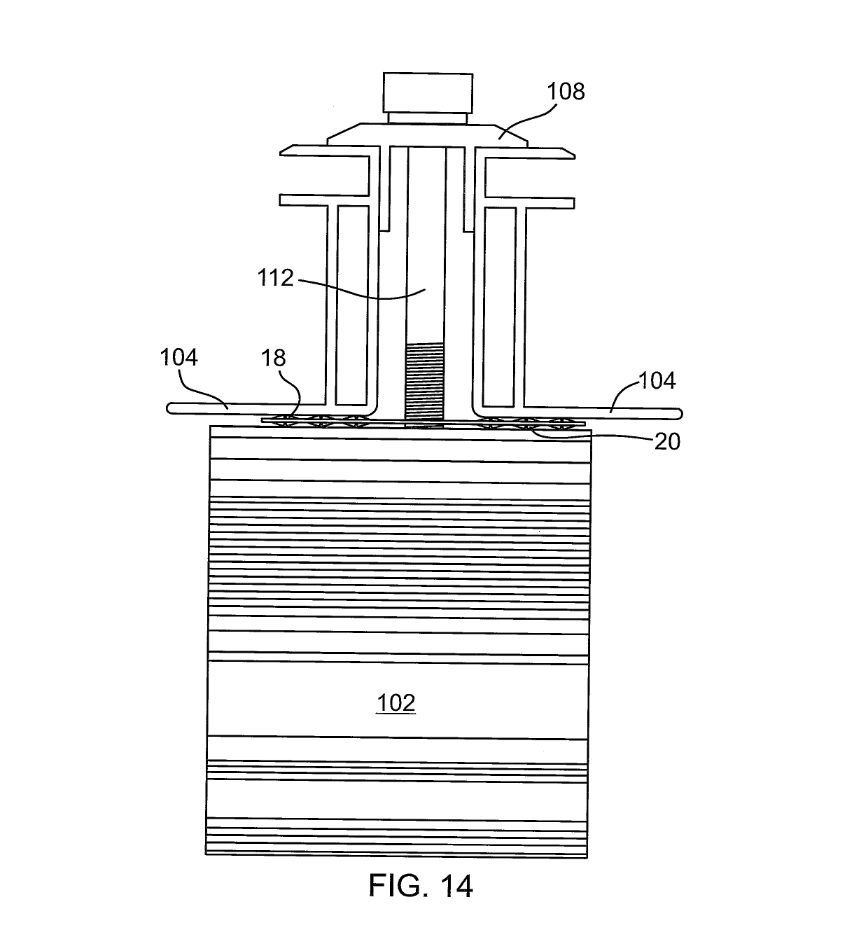

The metallic components 12 of solar panel racking system 100 commonly include one or more longitudinal rails 102 and one or more lateral rails 104. The lateral rails are typically perpendicularly disposed relative to the longitudinal rails, as shown in FIG. 1. A series of bonding washers 10 would normally be used to bond the longitudinal and lateral rails of a solar panel racking system, with a washer disposed between each junction of a longitudinal and lateral rail so that compression of the rails against each other causes the protrusions of the bonding washer to at least partially embed into the rails, as shown in FIG. 14.

Commonly, each lateral rail 104 of solar panel racking system 100 is releasably securable to a plurality of longitudinal rails 102 by one or more clamps 106. Each clamp 106 may be comprised of a retainer 108 and a nut 110 coupled to each other by a bolt 112. The washer will typically further include an opening 24 to accommodate the bolt, so that the washer can be disposed on the bolt between the nut and the retainer.

In one embodiment, washer 10 includes two or more downwardly depending flanges 26. In the embodiments shown in the figures, the washer has two downwardly depending flanges on opposing sides of the washer. Typically, flanges 26 are flexibly resilient so that when the washer is disposed atop nut 110, so that the flanges extend from the washer towards the nut, the washer can be forced onto the nut. As the washer is so forced, flanges 26 are forced outward by the nut to sprung positions at which point the flanges grippingly engage the nut. In that manner, the flanges releasably secure the washer to the nut, and thereby maintain the washer and the nut in fixed arrangement 200 relative to each other (see, e.g., FIG. 8).

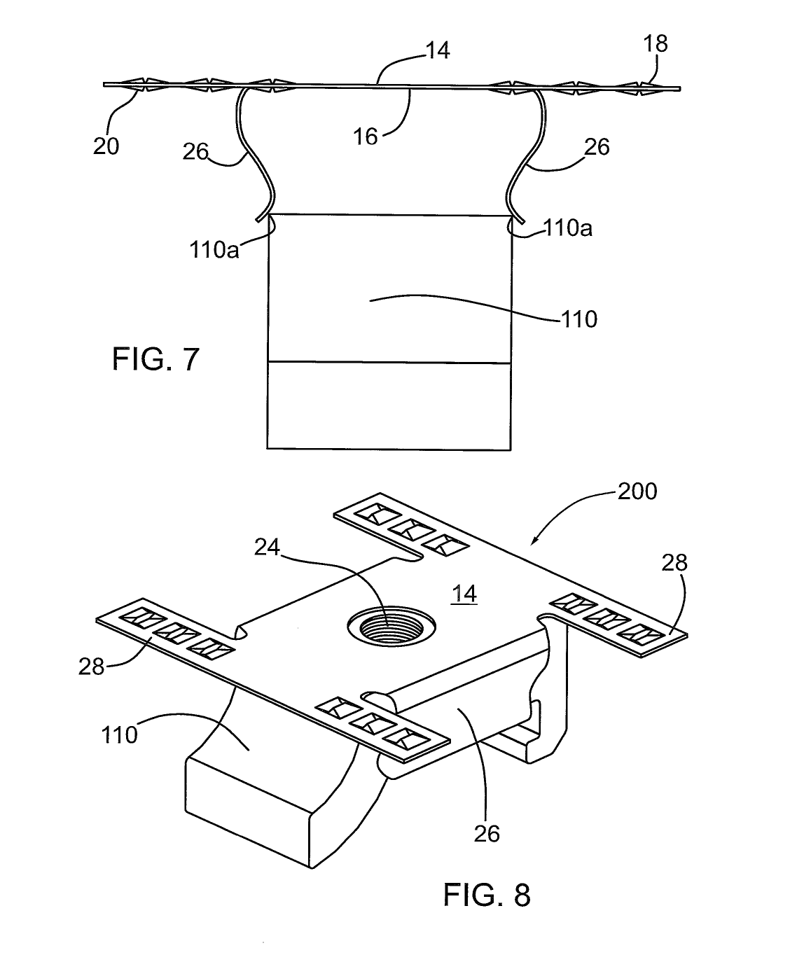

In order to facilitate the releasable securement of the washer to the nut, flanges 26 may be inwardly biased (i.e., biased toward each other). As shown in FIG. 4, to further facilitate the ability of the flanges to grippingly engage the nut, in one embodiment the inwardly biased flanges transition along bend 26a from inwardly biased portions 26b to outwardly flared end portions 26c. The outwardly flared end portions extend outwardly from the inwardly biased portions, and away from the lower surface of the washer. The outwardly flared end portions generally facilitate the releasable securement of the washer to the nut by facilitating the outward forcing of the flanges by the nut as the washer is forced onto the nut. By contacting the outwardly flared end portions 26c of the washer with edges 110a of nut 110 (as shown in FIG. 7), forcing of the washer upon the nut causes flanges 26 to be displaced outward until the nut is compressively held between the flanges. Bend 26a may be curved or sharp.

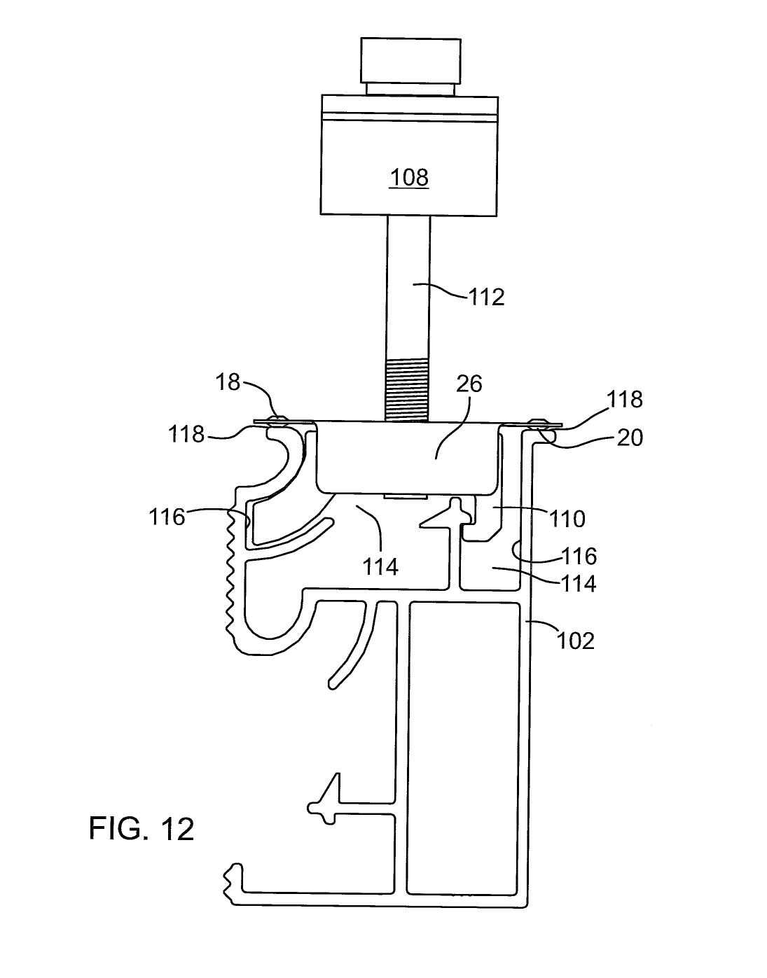

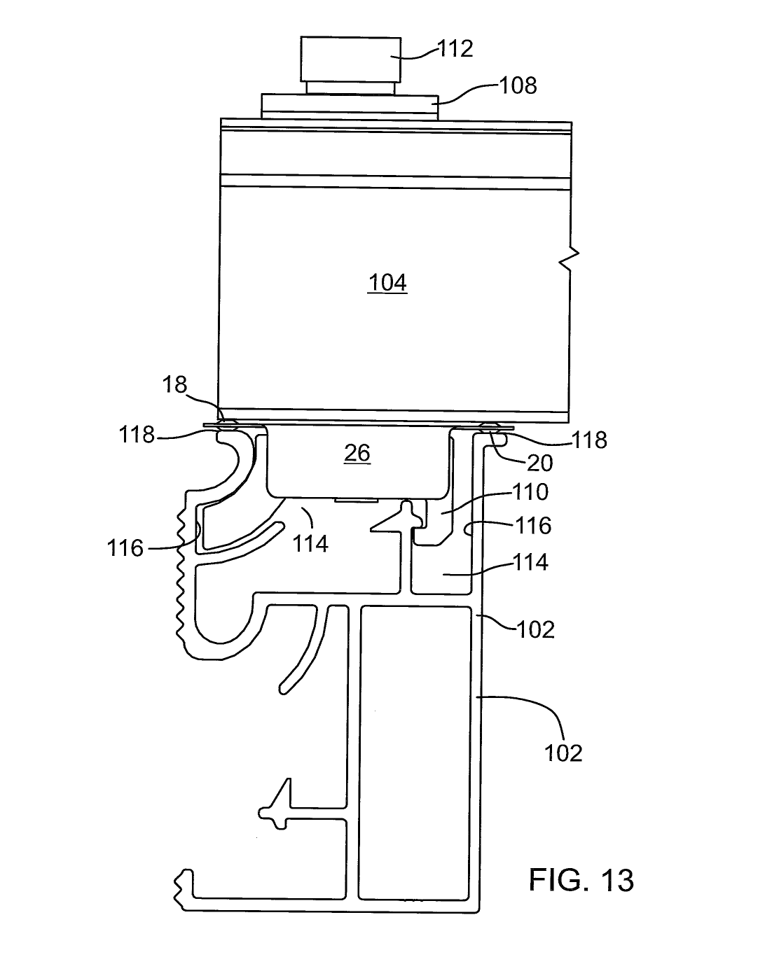

As shown in FIGS. 12 and 13, nut 110 may be slidably disposed within a channel 114 of longitudinal rail 102. The channel is flanked on either side by outer walls 116, each of which terminates in an elongate upper surface 118. Washer 10 may further include two opposed arm members 28. In embodiments having the arm members, the arm members are arranged generally parallel to each other, and the upper and lower protrusion pairs are disposed on the upper and lower surfaces of the arm members, respectively. As shown in FIGS. 13 and 14, when the washer and the nut are releasably secured to each other in fixed arrangement 200, and the nut is engaged to the longitudinal rail within channel 114, the lower protrusions on the arm members are substantially aligned with the elongate upper surfaces of the longitudinal rail for optimal embedding of the lower protrusions therein when the washer is compressed between the rails.

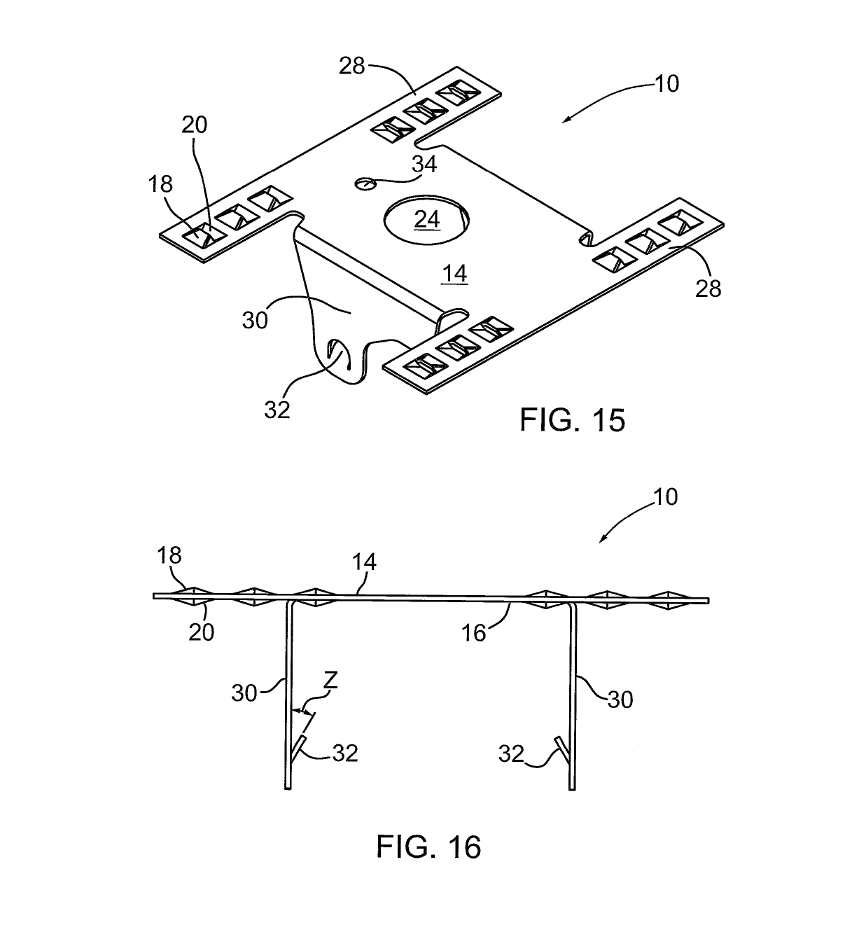

Referring to FIGS. 15 to 17, in accordance with an alternate embodiment, washer 10 includes two or more downwardly depending flanges 30. In the embodiment shown, washer 10 has two downwardly depending flanges 30 on opposing sides of the washer. When at rest, each flange 30 is arranged substantially perpendicular to upper and lower surfaces 14 and 16 of the washer. In this embodiment, each flange 30 includes a tab or louver 32 that projects inwardly. Each louver 32 is angled inwardly by an angle “Z” that is between 0° and 90° (see FIG. 16).

Each louver 32 is typically disposed on its respective flange such that, when washer 10 is placed atop nut 110 so that the flanges extend from the washer towards the nut, the washer can be forced onto the nut, with the louvers frictionally traversing the nut until the louvers clear the nut. The louvers are typically disposed on the respective flanges so that, when the washer is forced upon the nut, the louvers are positioned to clear the nut when or before the lower protrusions contact the rail. In some cases, the louvers may be disposed to clear the nut after the lower protrusions contact the rail, when the lower protrusions have embedded into the rail by a pre-determined amount. To facilitate the forcing of the washer upon the nut, angle “Z” is typically 45° or less.

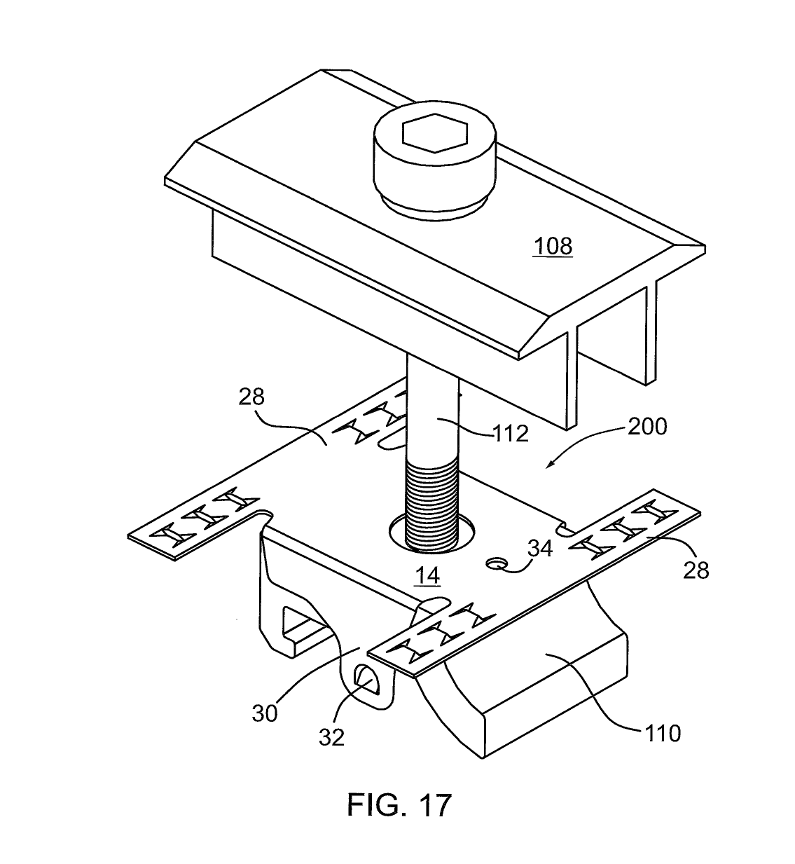

Further, flanges 30 are preferably flexibly resilient so that as the washer is forced upon the nut, the contact between the nut and louvers 32 forces each flange 30 outward to a sprung position. Once the louvers clear the sides of the nut, the flanges spring back to their respective resting positions, at which point the louvers extend beneath the nut to retain the washer on the nut, as shown in FIG. 17. Depending on the placement of the louvers on the respective flanges, once the louvers clear the sides of the nut, the louvers may frictionally engage the bottom of the nut, or, alternatively, may be spaced apart from the bottom of the nut (when the washer is at rest atop the nut). In the latter case, there will be room to move the washer up and away from the nut to a certain extent (e.g., by a few millimeters), while the flanges secure the washer to the nut in fixed arrangement 200, before the louvers contact the bottom of the nut to prevent further upward movement of the washer away from the nut. Further, once the louvers clear the sides of the nut and the flanges spring back to their respective resting positions, flanges 30 may either grippingly engage the nut, or there may be a certain amount of clearance between flanges 30 and the sides of the nut. The clearance between the flanges and the nut will allow washer 10 to be slid longitudinally, and slightly laterally, relative to the nut, which will generally facilitate alignment of washer opening 24 and the opening in nut 110 for receipt of bolt 112 therethrough.

Washer 10 may further include a directional indicator 34 on upper surface 14. The directional indicator may be formed as an opening in the washer, as shown in FIGS. 15 and 17. Alternatively, the indicator may be formed as an impression in the upper washer surface, such as by etching, scoring, or stamping, or it may be in the form of a pictorial representation, such as a coloured indicator painted, stamped, or otherwise applied to the upper washer surface (e.g., a red dot).

When washer 10 is releasably secured to nut 110, by flanges 26 or flanges 30, the nut may be substantially obscured from view when looking down upon the washer and the nut from above. Where the washer is used with asymmetrical nuts, such as nut 110 shown in the figures, users can releasably secure each washer to a respective nut so that directional indicator 34 is always pointed toward the same end of the nut. It is expected that the directional indicator will allow users to relatively quickly and easily identify the orientation of the nuts to which the washers are releasably secured.

Use of washer 10 will tend to improve bonding between metallic components through at least a partial embedding of protrusions 18, 20 into the metallic components. The embedding improves bonding by reducing exposure of the contacting portions of the protrusions and the metallic components to external environmental conditions. As such, the build-up of grime, dirt, oil, grease, and/or corrosion, that is commonly observed when metallic components are in contact, is expected to be reduced when washer 10 is utilized.

Further, relative movement between metallic parts that are abutted against each other, due to possible slippage resulting from buildup of the kind described, or changes in temperature causing expansion and contraction of the components, could result in a loss of bonding contact between the components. The embedding of the protrusions of washer 10 into the metallic components helps to reduce such relative movement and thereby increase the likelihood that the metallic components remain bonded.

The ability to retain the protrusions of washer 10 in bonding contact with the metallic components of the racking system is further enhanced in embodiments having flanges 26 or flanges 30, which assist in maintaining the washer and the nut in fixed arrangement 200, with lower protrusions 20 substantially aligned with elongate upper surfaces 118 of the longitudinal rails. Where flanges are utilized, the opposing arm members of the washer, when the washer is in fixed arrangement 200, will generally align with the elongate upper surfaces 118 of the longitudinal rails. Establishing and maintaining an electrical bond between the lower protrusions and the longitudinal rail will thus become a relatively simple task upon compression of the lateral and longitudinal rails against the washer. Washer 10, having flanges 26 or 30, will help to obviate the need for manual adjustment of the washer (to ensure protrusion alignment with the longitudinal rail) as the clamp is tightened.

Further, the releasable engagement between the washer and the nut helps to prevent, or substantially prevent, the washer from rotating or otherwise moving relative to the nut when the nut is received within channel 114 of rail 102.

It will further be appreciated that the directional indicator will facilitate the pre-assembly and on-site installation processes where asymmetrical nuts are used. An installer of a solar racking system can use the indicator as a point of reference that identifies the orientation of the underlying nut, which may be obscured from view by the washer or other components.

Depending on the shape or configuration of the metallic components, washer 10 may include arm members and/or protrusions that are configured, dimensioned, and/or disposed in a manner other than that shown in the figures. The arrangement of the arm members and/or protrusions will be such that when the flanges releasably secure the washer to the nut in fixed arrangement 200 (or in a fixed arrangement other than that shown in the figures), the protrusions will be substantially aligned with the metallic components.

It is to be understood that what has been described are exemplary embodiments of the invention. The scope of the claims should not be limited by the embodiments set forth above, but should be given the broadest interpretation consistent with the description as a whole.

What is claimed is:

1. A washer for electrically bonding metallic components of a solar panel racking system, the washer comprising:
an upper surface and a lower surface;
a series of spaced apart upper protrusions on said upper surface;
a series of spaced apart lower protrusions on said lower surface;
each of said upper protrusions corresponding to an opposing one of said lower protrusions to form an upper and lower protrusion pair, each said upper and lower protrusion pair being formed along a common plane; and
wherein compression of the washer between the metallic components causes the protrusions to at least partially embed into the components and to electrically bond the components.

2. The washer of claim 1, wherein the metallic components comprise one or more longitudinal rails and one or more lateral rails disposed generally perpendicular to the longitudinal rails, the washer being disposed between a lateral rail and a longitudinal rail;
wherein the compression causes said upper protrusions to at least partially embed into the lateral rail and said lower protrusions to at least partially embed into the longitudinal rail.

3. The washer of claim 2, wherein each of the one or more lateral rails is releasably securable to a plurality of longitudinal rails by a plurality of clamps, each of the clamps including a nut, the washer further comprising downwardly depending flanges that releasably secure the washer to the nut to maintain a fixed arrangement between the washer and the nut.

4. The washer of claim 3 further comprising two, generally parallel, opposed arm members, said upper and lower protrusion pairs being disposed on said arm members; and
wherein, when, in use, the washer and the nut are releasably secured in said fixed arrangement by releasable attachment of the downwardly depending flanges to the nut, said lower protrusions on said arm members are substantially aligned with elongate upper surfaces of the longitudinal rail.

5. The washer of claim 3, wherein said downwardly depending flanges are flexibly resilient such that as the washer is releasably secured to the nut, the nut forces said flexibly resilient flanges outward.

6. The washer of claim 5, wherein said downwardly depending flanges are inwardly biased toward each other to facilitate the releasable securement of the washer to the nut by the flanges.

7. The washer of claim 6, wherein each said flange transitions from an inwardly biased portion to an outwardly flared end portion, the outwardly flared end portions facilitating the releasable securement of the washer to the nut.

8. The washer of claim 5, wherein said downwardly depending flanges are arranged substantially perpendicular to the upper and lower surfaces of the washer.

9. The washer of claim 8 having two opposed said flanges, each said opposed flange including an inwardly extending louver.

10. The washer of claim 9, wherein each said louver is angled inward from its respective flange by an angle between 0° and 90°.

11. The washer of claim 10, wherein, as said washer is received onto the nut, said louvers frictionally traverse the nut until said louvers clear the nut, thereafter said louvers extending beneath the nut to retain said washer on the nut.

12. The washer of claim 3 further comprising a directional indicator on said upper surface, said directional indicator indicating an orientation of the nut to which said washer is releasably secured.

13. The washer of claim 1, wherein said common plane is normal to said upper and lower washer surfaces.

14. The washer of claim 1, wherein said common plane is oblique relative to said upper and lower washer surfaces.

15. A washer for electrically bonding metallic components of a solar panel racking system, the components releasably securable to each other by a plurality of clamps, each of the clamps including a nut, the washer comprising:
an upper surface and a lower surface;
a series of spaced apart upper protrusions on said upper surface;
a series of spaced apart lower protrusions on said lower surface;
downwardly depending flanges that releasably secure said washer to the nut to maintain a fixed arrangement between said washer and the nut;
each of said upper protrusions corresponding to an opposing one of said lower protrusions to form an upper and lower protrusion pair, each said upper and lower protrusion pair being formed along a common plane; and
wherein compression of the washer between the metallic components causes said protrusions to at least partially embed into the components and to electrically bond the components, said protrusions being substantially aligned with said components when said washer and the nut are in said fixed arrangement.

16. The washer of claim 15, wherein said downwardly depending flanges are flexibly resilient.

17. The washer of claim 16, wherein said downwardly depending flanges are inwardly biased toward each other to facilitate the releasable securement of said washer to the nut by said flanges.

18. The washer of claim 16 having two opposed said flanges, each said opposed flange including an inwardly extending louver; and
wherein, as said washer is received onto the nut, said louvers frictionally traverse the nut until said louvers clear the nut, thereafter said louvers extending beneath the nut to retain said washer on the nut.

19. A washer for electrically bonding metallic components of a solar panel racking system, the components releasably securable to each other by a plurality of clamps, each of the clamps including a nut, the washer comprising:
an upper surface and a lower surface;
a series of spaced apart upper protrusions on said upper surface;
a series of spaced apart lower protrusions on said lower surface;
downwardly depending flanges that releasably secure said washer to the nut to maintain a fixed arrangement between said washer and the nut, said flanges being flexibly resilient and each said flange including an inwardly extending louver, wherein, as said washer is received onto the nut, said louvers frictionally traverse the nut until said louvers clear the nut, thereafter said louvers extending beneath the nut to retain said washer on the nut;
each of said upper protrusions corresponding to an opposing one of said lower protrusions to form an upper and lower protrusion pair, each said upper and lower protrusion pair being formed along a common plane; and
wherein compression of the washer between the metallic components causes said protrusions to at least partially embed into the components and to electrically bond the components, said protrusions being substantially aligned with said components when said washer and the nut are in said fixed arrangement.

20. The washer of claim 19 further comprising a directional indicator on said upper surface, said directional indicator indicating an orientation of the nut to which said washer is releasably secured.
